(19) United States
(12) Patent Application Publication
(10) Pub. No.: US 2002/0169601 A1
(43) Pub. Date: Nov. 14, 2002

(54) Encoding device, decoding device, and broadcast system

(76) Inventor: Kosuke Nishio, Moriguchi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/140,881

(22) Filed: May 9, 2002

(30) Foreign Application Priority Data
May 11, 2001 (JP) 2001-141211

(51) Int. Cl. G10L 19/14

(52) U.S. Cl. 704/205

(57) ABSTRACT

A broadcast system 100 includes a broadcast station 110 and a plurality of homes 120. In the broadcast station 110 and each of the homes 120, an encoding device 111 and a decoding device 122, respectively, are installed. The encoding device 111 includes: a converting unit 113 for extracting a frame of an audio signal and converting the extracted frame, which corresponds to a predetermined period, into a spectrum in a frequency domain; a spectral data integrating unit 114 for integrating at least two sets of spectral data contained in the spectrum into fewer sets of spectral data and outputting them as sets of integration data; and a quantizing unit 115 and an encoding unit 116 for quantizing and encoding the sets of integration data to produce and output the encoded data. The decoding device 122 includes: a decoding unit 124 and a dequantizing unit 125 for decoding and dequantizing input encoded data to produce dequantized data, and converting the dequantized data into a spectrum in the frequency domain; a spectral data expanding unit 126 for expanding each set of integration data in the spectrum into at least two sets of spectral data; and an inverse-converting unit 127 for converting each expanded set of spectral data into an audio signal in the time domain and outputting the audio signal.

### BACKGROUND OF THE INVENTION

(1) Field of the Invention

The present invention relates to technology for encoding and decoding digital audio data to reproduce high-quality sound.

(2) Description of Related Art

In recent years, a variety of audio compression methods have been developed. MPEG-2 Advanced Audio Coding (MPEG-2 AAC) is one of such compression methods, and is defined in detail in “ISO/IEC 13818-7 (MPEG-2 Advanced Audio Coding, AAC)”. The following briefly describes characteristics of MPEG-2 AAC that are related to the present invention.

Encoding and decoding by a conventional encoding device and a conventional decoding device are first described below. The encoding device receives digital audio data, and extracts audio data from the received audio data at fixed intervals. (Hereafter, this extracted audio data is called “sample data.”) The encoding device then converts the sample data in the time domain into spectral data in the frequency domain in accordance with Modified Discrete Cosine Transform (MDCT). This spectral data is then divided into a plurality of groups, and each of the groups is normalized and quantized. The quantized data is encoded in accordance with Huffman coding so that an encoded signal is produced. The encoded signal is converted into an MPEG-2 AAC bit stream and outputted. This bit stream is either sent to the decoding device via a transmission medium such as a broadcast wave and a communication network, or recorded on a recording medium, such as an optical disk including a compact disc (CD) and a digital versatile disc (DVD), a semiconductor, and a hard disk.

The decoding device receives the MPEG-2 AAC bit stream encoded by the encoding device via a transmission channel or via a recording medium. The decoding device then extracts the encoded signal from the received bit stream, and decodes the extracted encoded signal. More specifically, after extracting the encoded signal, the decoding device converts a stream format of the encoded signal into a format appropriate for data processing. The decoding device then decodes this encoded signal to produce quantized data, and dequantizes the quantized data to produce spectral data in the frequency domain. Following this, the decoding device converts the spectral data into the sample data in the time domain in accordance with Inverse Modified Discrete Cosine Transform (IMDCT). Sets of sample data produced in this way are combined in order, and outputted as digital audio data.

In actual MPEG-2 AAC encoding, other techniques are additionally used, which include gain control, Temporal Noise Shaping (TNS), a psychoacoustic model, M/S (Mid/Side) stereo, intensity stereo, prediction, and a bit reservoir.

The quality of such audio data as encoded by the encoding device and sent to the decoding device can be measured, for instance, by a reproduction band of the audio data after encoding. When an input signal is sampled at a 44.1-kHz sampling frequency, for instance, a reproduction band of this signal is 22.05 kHz. When the audio signal with the 22.05-kHz reproduction band or a wider reproduction band close to 22.05 kHz is encoded into encoded audio data without degradation, and all the encoded audio data is sent to the decoding device, then this audio data can be reproduced as high-quality sound. The width of a reproduction band, however, affects the number of values of spectral data, which in turn affects the amount of data for transmission. For instance, when an input signal is sampled at the sampling frequency of 44.1 kHz, spectral data generated from this signal is composed of 1,024 samples, which has the 22.05-kHz reproduction band. In order to secure the 22.05-kHz reproduction band, all the 1,024 samples of the spectral data needs to be transmitted. This requires an audio signal to be efficiently encoded so as to keep a size of the encoded audio signal within a range of a transmission rate of a transmission channel.

It is not realistic, however, to transmit as many as 1,024 samples of the spectral data via a low-rate transmission channel of, for instance, portable phones. This is to say, when all the spectral data with a wide reproduction band is transmitted at such low transmission rate while the size of the entire spectral data is adjusted for the low transmission rate, a data size assigned to each frequency band becomes extremely small. This intensifies effect of quantization noise, so that sound quality decreases through encoding.

In order to prevent such degradation, efficient audio signal transmission is achieved in many of audio signal encoding methods including MPEG-2 AAC by assigning weights to values of the spectral data and not transmitting low-weighted values. With this method, sufficient data size is assigned to spectral data in a low band, which is important for human hearing, to enhance its encoding accuracy, while spectral data in a high band is regarded as less important and is unlikely to be transmitted.

Although such techniques are used in MPEG-2 AAC, audio encoding technology that achieves higher-quality reproduction and better compression efficiency is now required. In other words, there is an increasing demand for technology of transmitting an audio signal in a higher band as well as a low band at a low transmission rate.

### SUMMARY OF THE INVENTION

The present invention is made to respond to the above increasing demand. An encoding device according to the present invention receives and encodes an audio signal, and includes: a converting unit operable to extract a part of the received audio signal, the extracted part forming a frame corresponding to a predetermined period, and to convert the extracted part into a spectrum in the frequency domain, the spectrum including a plurality of sets of spectral data; an integrating unit operable to integrate, in accordance with a predetermined function, at least two sets of spectral data in a part of the spectrum into fewer sets of spectral data, hereafter called integration data, and to output the fewer sets of integration data, wherein the part of the spectrum corresponds to a predetermined frequency band; and an encoding unit operable to quantize and encode the sets of integration data to produce and output the encoded data.

For the above encoding device, the integrating unit integrates sets of spectral data by using the predetermined function, which reduces the size of encoded data to be transmitted. This allows the encoded data to be reliably transmitted via a low-rate transmission channel. In addition to this, the present invention has another advantage as follows. The above integrating unit integrates at least two sets of spectral data in the predetermined frequency band. By setting, for instance, a high frequency band as the above predetermined frequency band and by having the integrating unit integrate spectral data in this high frequency band, to which human hearing is less sensitive, perceptible degradation in sound quality resulting from the integration can be minimized. Unlike a conventional technique with which an audio signal in a certain frequency band is not transmitted at all, the present invention transmits integration data representing spectral data in this certain frequency band. This therefore achieves sound quality enhanced in accordance with the transmitted integration data. In this way, the present invention can achieve both reduction in encoded data size and transmission of high-quality encoded data.

It is also another advantage of the present invention that encoded data produced by the encoding device of the present invention can be decoded by a conventional decoding device because at least two sets of spectral data in the predetermined frequency band are only integrated into fewer sets of spectral data. Although it is unavoidable that quality of sound reproduced by the conventional decoding device in the higher band is somewhat different from sound quality of an originally sampled audio signal, this perceptible change in the sound quality can be minimized by setting a higher frequency band, to which human hearing is less sensitive, as the above predetermined frequency band.

Another encoding device of the present invention integrates at least two sets of spectral data that are arranged consecutively or discontiguously in the frequency domain as at least one set of integration data. This allows spectral data in every frequency band to be used as integration data, instead of only using spectral data in selected frequency bands. Although a decoding device cannot completely restore original sound from the integration data and spectral data, the above encoding device is capable of drastically reducing the size of an encoded audio bit stream to be transmitted and still ensuring reproduction of high quality sound that is close to the original sound.

With another encoding device of the present invention, an integration method is determined in accordance with at least one of the plurality of sets of spectral data that constitute the spectrum, and at least two sets of spectral data in the spectrum are integrated using the determined integration method. This makes it possible to select an integration method appropriate for original sound and integrate spectral data by using the selected integration method. By not transmitting spectral data predicted as unnecessary for restoring the original sound, the present encoding device is capable of reducing the size of an encoded audio bit stream to be transmitted while minimizing perceptible degradation in sound quality resulting from the integration.

A decoding device of the present invention receives and decodes encoded data generated from a frame of an audio signal and restores the audio signal. The frame is extracted by an encoding device from the audio signal at predetermined time intervals. The decoding device includes: a dequantizing unit operable to decode and dequantize the received encoded data to produce dequantized data, and convert the dequantized data into a spectrum in the frequency domain, wherein the spectrum includes a plurality of sets of spectral data; an expanding unit operable to expand each of certain sets of spectral data, out of the plurality of sets of spectral data, into at least two sets of spectral data by using a predetermine inverse function, the certain sets of spectral data corresponding to a predetermined frequency band; and an inverse-converting unit operable to convert each expanded set of spectral data into an audio signal in the time domain and to output the audio signal.

The above decoding device is capable of restoring a spectrum containing the same number of sets of spectral data as the original spectrum from encoded data generated by the encoding device of the present invention. Unlike a conventional technique with which spectral data in a certain frequency band is not transmitted, the present decoding device is capable of restoring, in such frequency band, spectral data close to the original spectral data. The present decoding device therefore has an advantage of restoring an audio signal with a wider frequency band from encoded data having a smaller size.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing the construction of a broadcast system of one embodiment of the present invention;

FIG. 2A shows an example of a simplified waveform of audio data along a time axis extracted by an audio signal input unit shown in FIG. 1;

FIG. 2B shows an example of spectral data along a frequency axis which is generated by a converting unit shown in FIG. 1 from audio data along the time axis through MDCT conversion;

FIG. 3 shows example scale factor bands to which the converting unit assigns the spectral data;

FIG. 4A shows example spectral data outputted by the converting unit before it is integrated;

FIG. 4B shows example spectral data integrated by a spectral data integrating unit shown in FIG. 1;

FIG. 5 is a flowchart showing integration operation by the spectral data integrating unit as illustrated in FIGS. 4A-4B;

FIG. 6 shows example integration information generated when spectral data integration shown in FIGS. 4A-4B is performed;

FIG. 7A shows an example structure of an MPEG-2 AAC audio bit stream into which the integration information is inserted;

FIG. 7B shows another example structure of an MPEG-2 AAC audio bit stream into which the integration information is inserted;

FIG. 8A shows an example of unexpanded spectral data outputted by a dequantizing unit shown in FIG. 1;

FIG. 8B shows example spectral data expanded by a spectral data expanding unit shown in FIG. 1;

FIG. 9 is a flowchart showing expansion processing which is illustrated in FIG. 8 and performed by the spectral data expanding unit;

FIG. 10A shows an example of an integration target range within a frame;

FIG. 10B shows another example of an integration target range within a frame;

FIG. 10C shows another example of integration target ranges within a frame;

FIG. 11A shows an example state in which different integration target ranges are provided for different frames;

FIG. 11B shows another example state in which different integration target ranges are provided for different frames;

FIG. 12A shows an example combination of samples of spectral data to be integrated together;

FIG. 12B shows another example combination of samples of spectral data to be integrated together;

FIG. 12C shows another example combination of samples of spectral data to be integrated together;

FIG. 13A shows an example method for calculating an integration value from two consecutive samples of the spectral data;

FIG. 13B shows another example method for calculating an integration value from two consecutive samples of the spectral data;

FIG. 14A shows an example of spectral data in a higher band and scale factor bands before the spectral data is integrated;

FIG. 14B shows an example relationship between integrated spectral data in the higher band and scale factor bands; and

FIG. 14C shows relationship between integrated spectral data in the higher band and scale factor bands according to the embodiment of the present invention.

### DESCRIPTION OF THE PREFERRED EMBODIMENTS

The following describes a broadcast system 100 of the present invention based on embodiments and drawings.

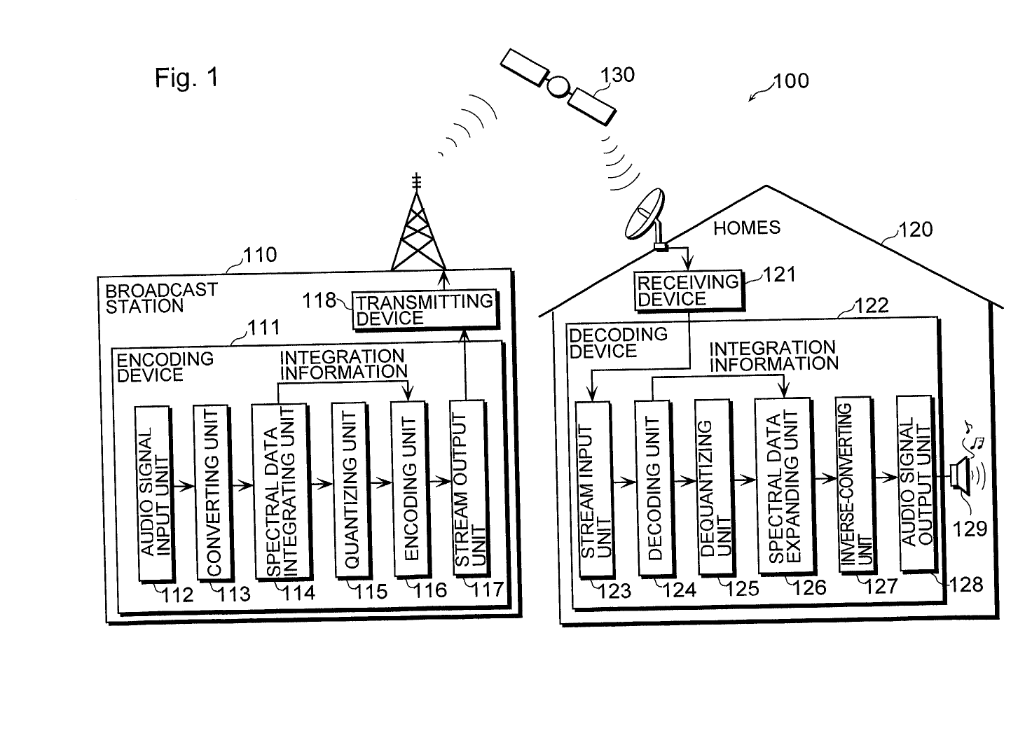

FIG. 1 is a block diagram showing the construction of the broadcast system 100 according to one embodiment of the invention. The broadcast system 100 includes a broadcast station 110 and a plurality of homes 120. The broadcast station 110 encodes an audio signal by using an encoding method of the present invention, and broadcasts it via a satellite broadcast wave. The homes 120 receive this broadcast wave via a broadcast satellite 130. In the homes 120, the encoded audio data included in the received broadcast wave is decoded to be reproduced as sound of movies, music, and the like.

Broadcast Station 110

The broadcast station 110 includes an encoding device 111 and a transmitting device 118. The encoding device 111 can produce an encoded audio bit stream having a smaller size than a conventional audio bit stream. This encoding device 111 is also capable of producing an audio bit stream to be decoded by a decoding device as a higher-quality audio signal than a conventional encoding device if the conventional device and the present device use an audio bit stream of the same size.

The encoding device 111 is achieved by either a program executed by a general-purpose computer, or hardware such as a dedicated circuit board or an LSI (large scale integration). The encoding device 111 includes an audio signal input unit 112, a converting unit 113, a spectral data integrating unit 114, a quantizing unit 115, an encoding unit 116, and a stream output unit 117.

The audio signal input unit 112 receives digital audio data sampled at a sampling frequency of, for instance, 44.1 kHz. From this digital audio data, the audio signal input unit 112 extracts every consecutive 1,024 samples. These 1,024 samples form a frame that is a unit of encoding. More specifically, at intervals of 22.7 milliseconds (msec), the audio signal input unit 112 outputs digital audio data composed of 2,048 samples, which consist of the above 1,024 samples and two sets of 512 samples obtained before and after the 1,024 samples. The two extracted sets of 512 samples overlap with other sets of 512 samples extracted before and after the present extraction. Hereafter, such digital audio data as extracted by the audio signal input unit 112 is called “sample data.”

The converting unit 113 converts this sample data in the time domain into spectral data in the frequency domain. In more detail, according to MDCT, the converting unit 113 converts the sample data composed of 2,048 samples to generate spectral data that also includes 2,048 samples. The samples of this spectral data generated according to MDCT are symmetrically arranged, and therefore only half (i.e., 1,024 samples) of them is used for the subsequent operations. The converting unit 113 then divides the spectral data composed of 1,024 samples into a plurality of groups, each of which simulates a critical band of human hearing. Each divided group is called a “scale factor band”, which is defined as containing spectral data composed of at least one sample (or, practically speaking, samples whose total number is a multiple of four). In MPEG-2 AAC, when sampling frequency is 44.1 kHz and each frame contains 1,024 samples, each frame is defined as containing 49 scale factor bands. The number of samples of spectral data contained in each scale factor band differs according to frequencies of each scale factor band. A scale factor band of lower frequencies contains less spectral data, and a scale factor band of higher frequencies contains more spectral data.

The spectral data integrating unit 114 receives the spectral data composed of 1,024 samples from the converting unit 113, and integrates spectral data composed of every two or more samples within a certain band into spectral data composed of less samples. In more detail, the spectral data integrating unit 114 integrates, using a predetermined function, every two of 512 samples in a higher band into one integration value representing the two integrated samples. This integration is performed by comparing absolute values of the two consecutive samples in the frequency domain with one another, regarding a sample that has a higher absolute value than the other as an integration value, and only outputting the integration value to the quantizing unit 115. As for other 512 samples in the lower band, the spectral data integrating unit 114 outputs them as they are to the quantizing unit 115. Consequently, every two samples of the spectral data in the higher band are integrated into an integration value. The spectral data integrating unit 114 also generates integration information showing that every two consecutive samples that constitute 512 samples in the higher band are integrated into a single integration value, and outputs the generated integration information to the encoding unit 116.

The quantizing unit 115 receives, from the spectral data integrating unit 114, the spectral data corresponding to a frame composed of 768 samples, which consist of 512 samples in the lower band and 256 samples in the higher band. The quantizing unit 115 then normalizes spectral data in each scale factor band by using a normalizing factor while preventing a bit size of the frame from exceeding a predetermined value. This normalizing factor is called a scale factor. In more detail, the quantizing unit 115 determines an appropriate scale factor for each scale factor band through approximate calculation so that an audio bit stream, which is a final form of the spectral data for a frame, can have a bit size within a transmission size of a transmission channel. The quantizing unit 115 then normalizes and quantizes the spectral data. The quantizing unit 115 outputs the quantized spectral data (hereafter called “quantized data”) and the scale factors used above to the encoding unit 116.

The encoding unit 116 encodes the quantized data and scale factors in accordance with Huffman coding, and converts the encoded data to generate an encoded signal in a predetermined stream format. Before encoding the scale factors, the encoding unit 116 calculates a difference in values of two scale factors used in every two consecutive scale factor bands, and encodes each calculated difference and a scale factor used in the first scale factor. Through Huffman coding, the encoding unit 116 also encodes the integration information sent from the spectral data integrating unit 114, and converts it to generate encoded integration information in the predetermined stream format, and outputs it and the above encoded signal to the stream output unit 117.

The stream output unit 117 adds header information and other necessary sub information to the above encoded signal, and converts it into an MPEG-2 AAC bit stream. The stream output unit 117 also inserts the encoded integration information into regions of the above bit stream which are ignored by a conventional decoding device or for which operation is undefined. The stream output unit 117 then outputs this MPEG-2 AAC bit stream.

The transmitting device 118 receives the encoded bit stream from the stream output unit 117, and sends it via a satellite broadcast wave to the broadcast satellite 130.

Homes 120

Each of the homes 120 includes a receiving device 121, a decoding device 122, and a speaker 129, thereby receiving the broadcast wave via the broadcast satellite 130, extracting and decoding the encoded bit stream in the received broadcast wave, and reproducing sound from the audio signal.

The receiving device 121 is achieved by a set top box (STB) or the like to receive the satellite broadcast wave, extract the encoded bit stream from the received broadcast wave, and output it to the decoding device 122.

The decoding device 122 is achieved, like the encoding device 111, by either a program executed by a general-purpose computer, or hardware such as a dedicated circuit board or an LSI. On receiving the encoded bit stream that includes the encoded signal and integration information, the decoding device 122 decodes the encoded signal representing audio data, and the encoded integration information showing how spectral data is integrated. In accordance with the decoded integration information, the decoding device 122 expands the integrated spectral data, and restores the audio data. The decoding device 122 includes a stream input unit 123, a decoding unit 124, a dequantizing unit 125, a spectral data expanding unit 126, an inverse-converting unit 127, and an audio signal output unit 128.

On receiving the encoded bit stream extracted by the receiving device 121, the stream input unit 123 extracts the Huffman-encoded signal representing the audio data, and the Huffman-encoded integration information, and outputs them to the decoding unit 124.

The decoding unit 124 receives the encoded signal and integration information in the stream format from the stream input unit 123. The decoding unit 124 then decodes the encoded signal to restore the quantized data and the differences in scale factors between scale factor bands. The decoding unit 124 then outputs them to the dequantizing unit 125. The decoding unit 124 also decodes the encoded integration information, and outputs the integration information to the spectral data expanding unit 126.

The dequantizing unit 125 dequantizes the quantized data composed of a frame of 768 samples which consist of 512 samples in the lower band and 256 samples in the higher band to restore the spectral data composed of 512 samples in the lower band and 256 integration values in the higher band.

The spectral data expanding unit 126 stores, in advance, various types of expanding methods associated with different integration information, and expands the restored spectral data composed of integration values to restore spectral data composed of 512 samples in the higher band.

In accordance with MPEG-2 AAC and IMDCT, the inverse-converting unit 127 converts the spectral data in the frequency domain into the sample data in the time domain.

The audio signal output unit 128 combines sets of sample data converted by the inverse-converting unit 127 with one another, and outputs it as digital audio data to the speaker 129.

The speaker 129 receives the digital audio data restored by the decoding device 122 in this way, and performs D/A (digital-to-analog) conversion on the digital audio data to generate an analog audio signal. In accordance with this analog signal, the speaker 129 reproduces music and sound.

The broadcast satellite 130 receives the broadcast wave from the broadcast station 110 and sends it to the ground.

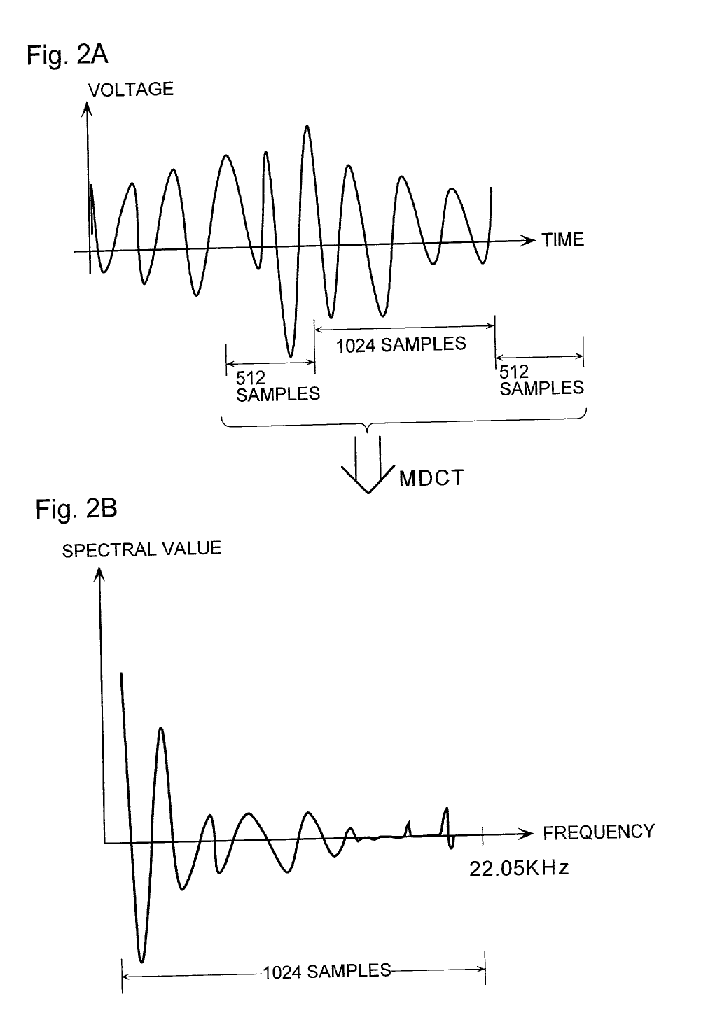

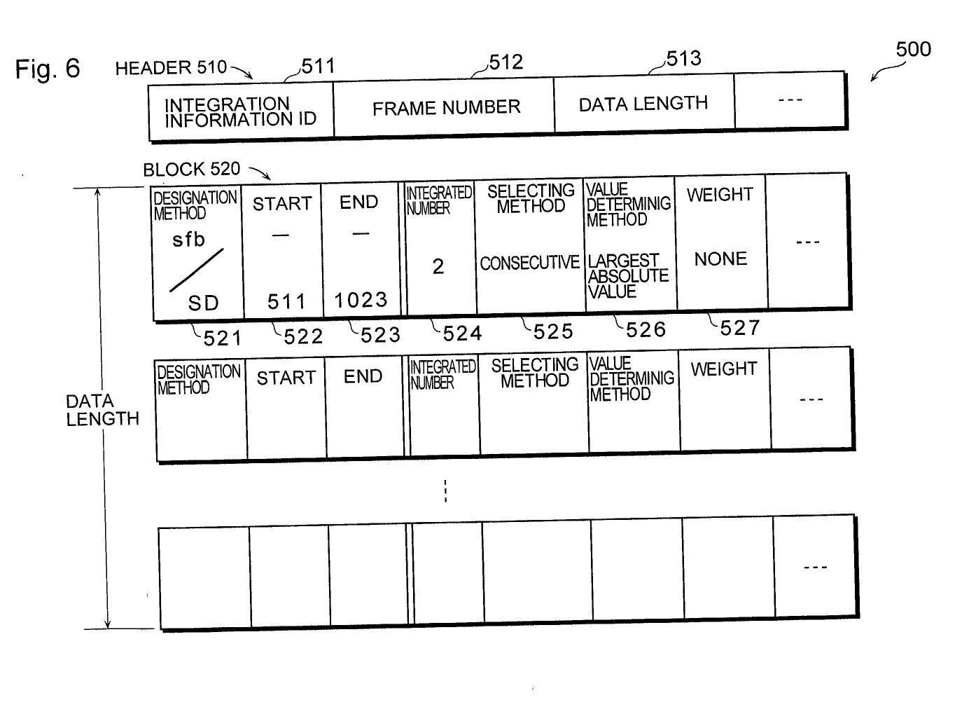

The following describes the processing of the encoding device 111 in the broadcast system 100 with reference to FIG. 2A˜FIG. 6.

FIG. 2A shows an example of a simplified waveform of the audio data along the time axis extracted by the audio signal input unit 112. FIG. 2B shows an example spectral data along the frequency axis generated by the converting unit 113 from the audio data through MDCT conversion. Note that the sample data and the spectral data are shown as continuous waveforms in FIGS. 2A and 2B although they are discrete sets of data in reality.

An audio signal is represented by a waveform of voltage that changes over time, as shown in FIG. 2A. In this figure, a voltage value along the vertical axis corresponds to sound intensity at a time. An audio signal waveform, in general, contains many frequency components. When a part of such audio signal corresponding to a fixed period is extracted and converted based on MDCT, resulting data is spectral data in which a ratio of each frequency component of the extracted signal has both negative and positive values, as shown in FIG. 2B.

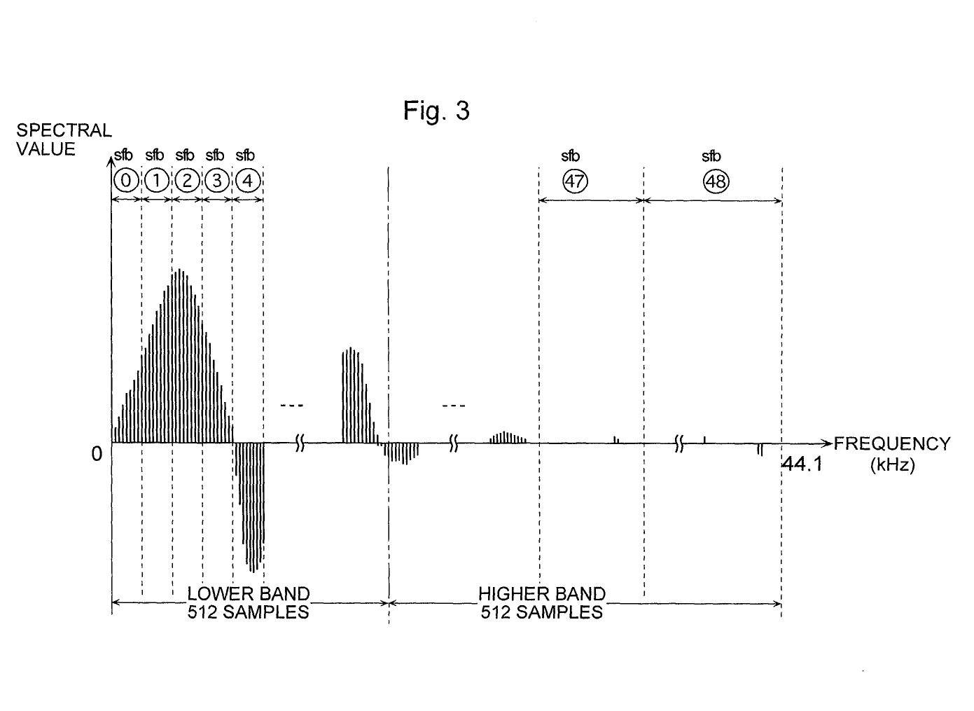

Based on characteristics of such audio signal and human hearing for the audio signal, signal processing in MPEG-2 AAC is performed using a scale factor band as a unit of quantization. FIG. 3 shows example scale factor bands based on which the converting unit 113 divides the spectral data. In this figure, each sample value of the spectral data is represented by a bar graph. In MPEG-2 AAC, the number of scale factor bands included in a frame is determined by whether a long or short block is used and by a sampling frequency of input audio data. The long block refers to a block of 2,048 samples for which the converting unit 113 performs MDCT conversion, and the short block refers to a block of 256 samples for the MDCT conversion. For instance, when the long block is used and the sampling frequency is 44.1 kHz as in the present embodiment, a frame includes 49 scale factor bands. In MPEG-2 AAC, the number of samples of the spectral data included in each scale factor band is determined in accordance with frequencies. More specifically, a scale factor band in a lower band includes fewer samples, and a scale factor band in a higher band includes more samples, as shown in FIG. 3. This is because high accuracy is required for encoding and decoding in low and middle bands since human hearing is sensitive to components of the audio signal in such low and middle bands. The quantizing unit 115 normalizes spectral data included in the same scale factor band by using the same scale factor and quantizes spectral data.

The quantizing unit 115 determines each scale factor while calculating a bit size used for transmission of a frame of encoded data. When the calculated bit size is extremely large for a transmission rate of the transmission channel, the quantizing unit 115 determines scale factors that make each of the quantized data values small so as to reduce the amount of encoded data. A value of the spectral data in the higher band, in particular, is likely to be reduced to quantized data having an extremely small value. Consequently, when the quantizing unit 115 performs normalization and quantization in a conventional manner, resulting values of the quantized data in the higher band are often successive zeros. When such quantized data having zero values are encoded, however, resulting data size of the encoded data is not zero. The encoding device 111 of the present embodiment therefore has the spectral data integrating unit 114 perform the following integration operation before quantization by the quantizing unit 115.

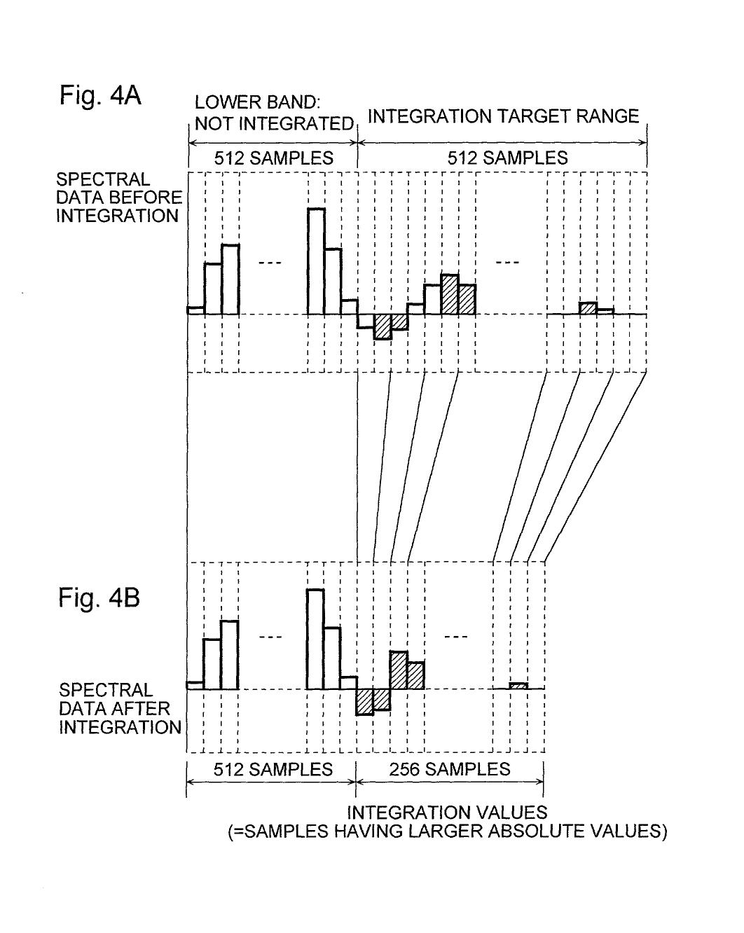

FIG. 4A shows example spectral data before integration outputted by the converting unit 113, and FIG. 4B shows example spectral data after integration by the spectral data integrating unit 114. As shown in FIG. 4A, out of a frame of 1,024 samples, 512 samples in the lower band are outputted as they are to the quantizing unit 115. As for the remaining 512 samples in the higher band, an integration value is obtained from every two consecutive samples along the frequency axis as shown in FIG. 4B. Each integration value of the spectral data is then outputted to the quantizing unit 115 as shown in the figure. In this figure, absolute values of every two consecutive samples of the spectral data are compared with each other, and a sample having a larger absolute value (which is represented by a shaded bar in the figure) is used as an integration value. In this way, the spectral data in the higher band composed of 512 samples shown in FIG. 4A are integrated by the spectral data integrating unit 114 into 256 integration values shown in FIG. 4B.

As a result of such integration of two samples into a single sample, a size of data after encoding is reduced by the size of samples unused for encoding. In addition, as this integration drastically reduces the number of samples of spectral data to be quantized, the quantizing unit 115 can adjust a scale factor so as to prevent quantized data in the higher band from taking a zero value when spectral data values in the higher band are not zero.

Moreover, the above use of a sample having a larger absolute value as an integration value not only reduces transmission data amount by the size of a repetitive sample when two consecutive samples in the higher band are zero but also allows a nonzero value to be used as an integration value when one of the two consecutive samples is zero and the other is not zero.

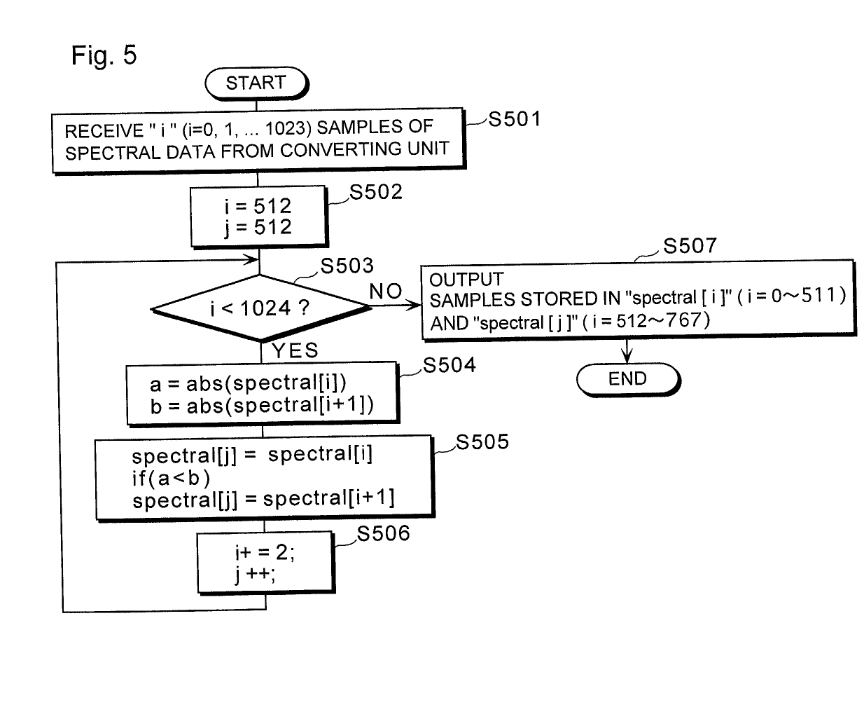

The spectral data integrating unit 114 performs such integration according to the following procedure. FIG. 5 is a flowchart showing the integration operation by the spectral data integrating unit 114. In the figure, “i” and “j” represent ordinal numbers assigned to samples of the spectral data. Registers used in this procedure are regions that temporarily store a variable value.

The spectral data integrating unit 114 receives a frame of 1,024 samples of spectral data from the converting unit 113, and places each of them into a different storage region “spectral [i]” (i=0, 1, . . . 1023) represented by one-dimensional array (step S501). The spectral data integrating unit 114 then places “512” into registers “I” and “j” to perform the following operation on the 512nd sample (i.e., the first sample in the higher band) and the remaining samples in the higher band of the spectral data (step S502). The data integrating unit 114 then judges whether a value in the register “i” is lower than “1024” (step S503). If so, integration is not completed, and so an absolute value “abs” of the ith spectral data is calculated and placed into a register “a.” Following this, an absolute value “abs” of the (i+1)th spectral data is calculated and placed into the register “b” (step S504). For the present example, an absolute value of the 512nd sample of the spectral data is placed into the register “a” and an absolute value of the 513rd sample is placed into the register “b.”

Into a storage region “spectral [j]” for storing jth sample of the spectral data, ith sample is placed in advance. For the present example, the 512nd (ith) sample is placed into the storage region “spectral [j=512].” The spectral data integrating unit 114 then compares the absolute values “abs” of the ith and (i+1)th samples stored in the registers “a” and “b”, respectively, with each other. This is to say, an absolute value of the 512nd sample is compared with an absolute value of the 513rd sample. If the absolute value of the (i+1)th sample in the register “b” is larger than the absolute value of the ith sample in the register “a”, the spectral data integrating unit 114 overwrites the (i+1)th sample on the value in the storage region “spectral [j].” (step S505) For the present example, assume that the 513rd samples in the register “b” has a larger absolute value than the 512nd samples in the register “b.” Then the 513rd sample is overwritten on the value in the storage region “spectral [j=512]” so that values in the storage regions “spectral [j=512]” and “spectral [i=513]” become the same. Following this, the spectral data integrating unit 114 increments “i” and “j” by “2” and “1”, respectively (step S506), and the control flow returns to step S503. At this point, “i” is “514”, and “j” is “513.”

After this, the processing in steps S503-S506 are repeated, so that the spectral data integrating unit 114 compares absolute values of two consecutive samples of the spectral data with each other, and writes a sample having a larger absolute value in a storage region “spectral [j]” represented by an array of “j.” As a result, when “i” is judged as “1024” or higher in step S503, the storage regions “spectral [j]” (j=512, 513, . . . 767) store 256 samples (i.e., integration values) that each integrate two out of 512 samples in the higher band. The control flow then moves to the next step (step S507), where the spectral data integrating unit 114 sends 0th˜767th samples stored in different storage regions “spectral [i]” (i=0˜511) and “spectral [j]” (j=512˜767) to the quantizing unit 115, and completes integration processing, except for generation of integration information.

The above integration reduces 512 samples of the spectral data in the higher band to 256 samples, reducing a frame composed of 1,024 samples to a frame of 768 samples. In this way, the spectral data integrating unit 114 is capable of reducing the amount of the spectral data in the higher band through simple operation. The spectral data integrating unit 114 then places a predetermined number of samples, out of the 768 samples, into each scale factor band in order of frequencies of the samples, the sample of the lowest frequency first. As each scale factor band used here is originally provided for a frame of 1,024 samples, placing 768 samples into such scale factor bands not only reduces the total number of scale factor bands and, therefore, the load of quantization, but also the number of scale factors to be transmitted and, therefore, the size of the encoded signal to be transmitted. In this way, the above integration operation achieves drastic reduction in the number of samples of the spectral data when compared with the conventional technology. Accordingly, the encoding device 111 of the present invention can assign a larger bit size to each set of quantized data than a conventional encoding device when the conventional device and the present device 111 use an encoded bit stream of the same size.

The above integration is only performed for samples of the spectral data in the higher band because human hearing is more sensitive to degradation in reproduced sound in the lower-band, which results from the integration.

FIG. 6 shows example integration information 500 generated when integration of the spectral data shown in FIG. 4 has been performed. The integration information 500 includes a header 510 and one or more blocks 520. The header 510 shows information regarding the integration information 500, and includes an integration information ID (identifier) 511, a frame number 512, and a data length 513. The integration information ID 511 is the ID specifying the integration information 500. The frame number 512 identifies a frame for which integration specified by the integration information 500 is performed. The data length 513 shows a bit length of data from the start of the first block 520 to the end of the last block within the integration information 500.

Each block 520 includes specific information regarding integration operation, and this information is provided whenever integration method changes within the frame. More specifically, each block 520 is divided into an area specifying an integration target range and into an area specifying a detailed integration method used in the specified integration target range. The area specifying the integration target range includes items of designation method 521, start 522, and end 523. The designation method 521 shows whether the integration target range is designated by either a scale factor band number “sfb” or a spectral data number “SD”. When the designation method 521 is shown as “sfb”, the integration target range is designated by scale factor band numbers indicated by the start 522 and the end 523. When the designation method 521 is shown as “SD” on the other hand, the integration target range is designated by a spectral data number indicated by the start 522 and the end 523. In this way, the start 522 is shown as a value indicting the start of the integration target range in accordance with the designation method 521. The end 523 is shown as a value indicating the end of the target range in accordance with the designation method 521. For instance, the numbers consisting of “0”˜“1023” are serially assigned to samples of the spectral data. When 512 samples in the higher band are integrated in accordance with the same integration method, and the designation method 521 is shown as “SD”, then the start 522 and the end 523 are shown as “511” and “1023”, respectively.

The area designating an integration method in each block 520 includes an integrated number 524, a selection method 525, a value determining method 526, and a weight 527. The integrated number 524 shows a number of samples of the spectral data to be integrated. It is shown as “2” in the figure, which means that two samples of the spectral data are integrated. The selection method 525 shows how samples of the spectral data are selected to be integrated. For instance, the selection method 525 shows that samples indicated by the integrated number 524 are consecutively selected for integration, or that every other sample is selected to be integrated together. In the figure, the selecting method 525 is shown as “consecutive.” The value determining method 526 shows a method for determining an integration value from the selected samples of spectral data. It is shown as the “largest absolute value” in the figure, which means that a sample that has the largest absolute value of all the samples selected above is regarded as an integration value. The weight 527 shows whether a weight is assigned to a sample of the spectral data selected above such as by multiplying each selected sample by a factor. If a weight is assigned, the weight 527 also shows a sample to which the weight is assigned and a weighing factor. In the figure, the weight 527 is shown as “none.”

The decoding device 122 refers to this integration information 500, and recognizes, for the sent frame, that every two consecutive samples, out of 512 samples in the higher band, are integrated into an integration value, which is one of the two samples having a higher absolute value. In accordance with this information 500, the decoding device 122 can restore spectral data that is close to the original spectral data. In the above example, the integration information 500 includes only one block 520 because this single block 520 designates integration for the entire frame. If a plurality of integration methods are used within a single frame, however, a plurality of blocks are provided in the integration information.

The integration information 500 is described above as including at least one block 520. It is possible to delete, from such block 520, predetermined items that are notified beforehand to the encoding device 11 and the decoding device 122. For instance, if it is predetermined that 512 samples in the higher band are always integrated using the same integration method, the items in the block 520 that specify an integration target range, that is, the designation method 521, the start 522, and the end 523 may be deleted from the integration information 500. Other items in the block 520 may be also deleted. For instance, the item of the weight 527 may be deleted from the integration information 500 for a frame or an integration target range to which no weight is assigned. The item of the weight 527 may be therefore included in the integration information 500 only for a frame or an integration target range in which weights are assigned, with a weighting factor also written in the field of the weight 527.

The above integration information 500 is encoded using Huffman coding, converted into data in a format for a stream, and inserted into regions that are contained in an MPEG-2 AAC bit stream converted from the encoded signal and that are ignored by a conventional decoding device or for which operation is undefined.

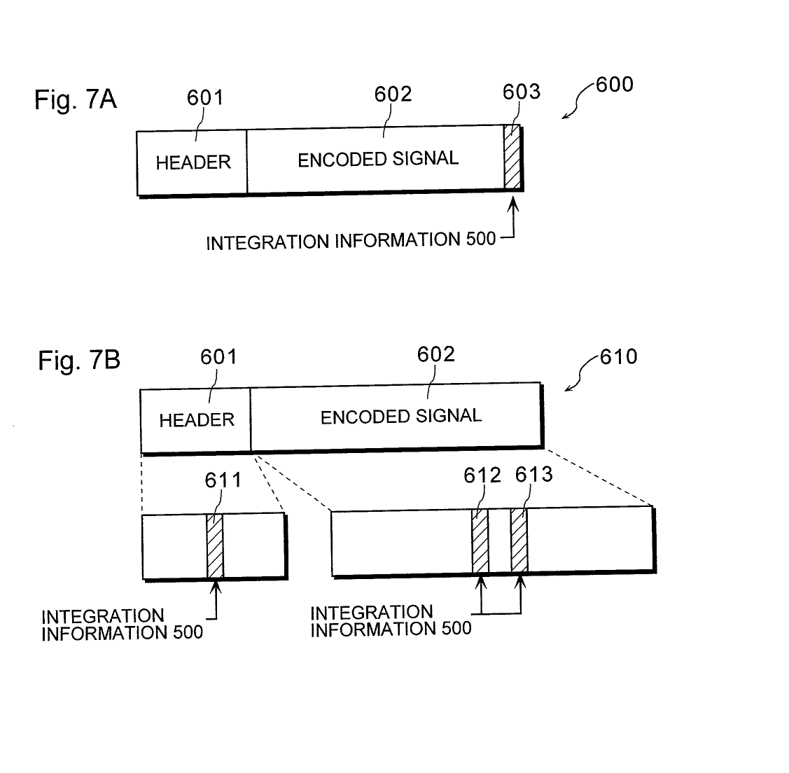

FIG. 7A shows the example data structure of an MPEG-2 AAC bit stream 600 into which the integration information 500 is inserted. FIG. 7B shows another example data structure of an AAC bit stream 610 including the integration information 500. The integration information 500 is inserted into shaded parts of theses encoded audio bit streams shown in the figures. As shown in FIG. 7A, the MPEG-2 AAC bit stream 600 includes a header 601, an encoded signal 602, and a region 603 such as Fill Element and Data Stream Element (DSE). The header 601 includes information regarding this bit stream 600, such as an ID indicating that this stream complies with MPEG-2 AAC, a data length of the bit stream 600, a frame number that corresponds to the encoded signal 602, and the number of scale factors corresponding to the encoded signal 602. The encoded signal 602 is generated by quantizing and encoding the spectral data integrated by the spectral data integrating unit 114 to produce an encoded signal and by converting a format of this encoded signal.

Fill Element conventionally includes: (a) header information containing a Fill Element ID specifying that this data is Fill Element, and data showing a bit length of the whole Fill Element; and (b) a region filled with zero to make a data length of the AAC bit stream 600 a fixed predetermined value. When the region 603 is Fill Element, for instance, the integration information 500 is recorded in the stated region filled with zero. When the integration information 500 is recorded in Fill Element in this way, a conventional decoding device does not recognize the information 500 as an encoded signal that should be decoded, and ignores it.

DSE is provided in anticipation of future extension for MPEG-2 AAC, and only its physical structure is defined in MPEG-2 AAC. As in Fill Element, DSE also includes header information containing a DSE ID showing that the subsequent data is DSE, and data showing a bit length of the whole DSE. When the region 603 is DSE, for instance, the integration information 500 is recorded in a data region that follows the header information. When the conventional decoding device reads the integration information 500 contained in such DSE, the conventional decoding device does not perform any operations in response to the read information 500 since operation that should be performed by the conventional decoding device in response to the information 500 is not defined.

Accordingly, when the conventional device receives the encoded audio bit stream containing the integration information 500 in the above region from the encoding device 111 of the present invention, the conventional decoding device does not decode the integration information 500 as an encoded audio signal. This therefore prevents the conventional decoding device from producing noise resulting from failed decoding of the integration information 500. It is unavoidable, however, that quality of reproduced sound in the higher band is not the same as that of an originally sampled audio signal when the conventional decoding device reproduces the above audio bit stream. This is because the integrated spectral data in the higher band shifts close to the lower-band side in accordance with the number of samples unused as integration values, and this narrows a band of reproduced sound in the higher band.

DSE is described above as being inserted in the region 603 at the end of the encoded audio bit stream. It is alternatively possible, however, to insert DSE between the header 601 and the encoded signal 602, or into the encoded signal 602.

In the above explanation, the integration information 500 is stored in a region, contained in an MPEG-2 AAC bit stream, that is ignored by the conventional decoding device. However, when the encoded audio bit stream 610 is only sent to the decoding device 122 of the present invention, the integration information 500 may be inserted into a predetermined region 611 within the header 601, or into a predetermined region (such as a region 612) other than the region 603 of the encoded signal 602, or into both the header 601 and the encoded signal 602 (such as the regions 611 and 612). It is not necessary to secure a continuous region in the encoded audio bit stream 610 for storing the integration information 500, with this applying to both the header 601 and the encoded signal 602. For instance, the integration information 500 may be inserted into both the predetermined regions 612 and 613 within the encoded signal 602.

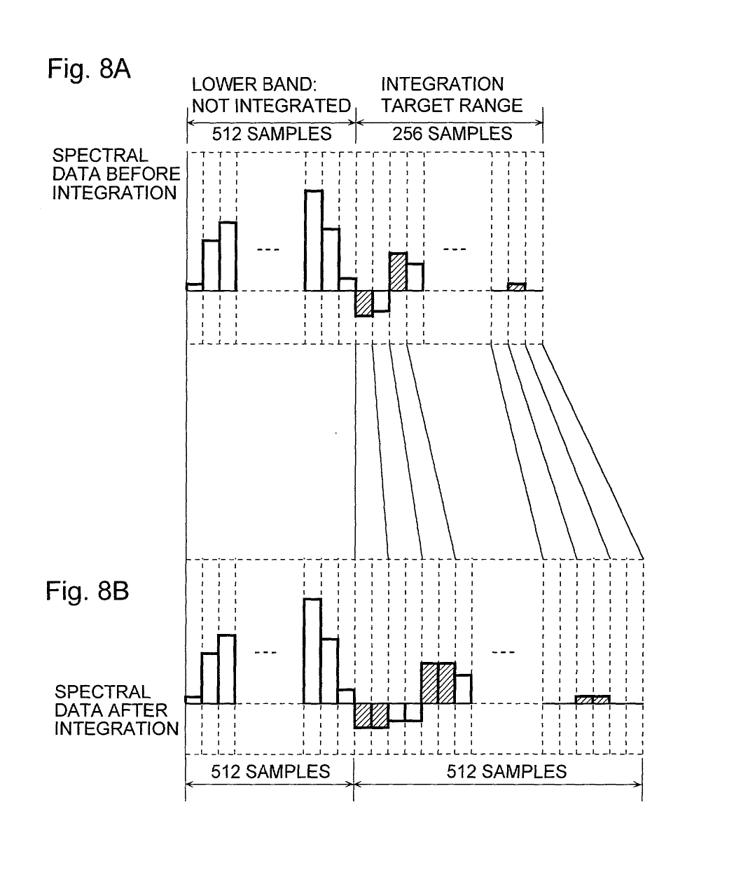

The decoding device 122 receives the above encoded audio bit stream via the satellite broadcast wave, extracts the encoded signal from the received audio bit stream, and decodes the encoded signal. After dequantizing this encoded signal to restore the integrated spectral data, the decoding device 122 expands 256 integration values in the higher band of the integrated spectral data into 512 samples. FIG. 8A shows an example of the integrated spectral data outputted by the dequantizing unit 125. FIG. 8B shows example spectral data expanded by the spectral data expanding unit 126. The expanding method used here for expanding a frame of 768 integration values, which are results of dequantization by the dequantizing unit 125, into 1,024 samples corresponds to the spectral data integrating method shown in FIG. 4. More specifically, as shown in FIG. 8A, of all the 768 samples, the spectral data expanding unit 126 leaves 512 samples in the lower band as they are and expands 256 integration values in the higher band into the spectral data composed of 512 samples in which every two consecutive sample values along the frequency axis are the same. By comparing the expanded spectral data shown in FIG. 8B with spectral data based on original sound shown in FIG. 4A, it can be observed that the expanded spectral data and the original spectral data are roughly the same.

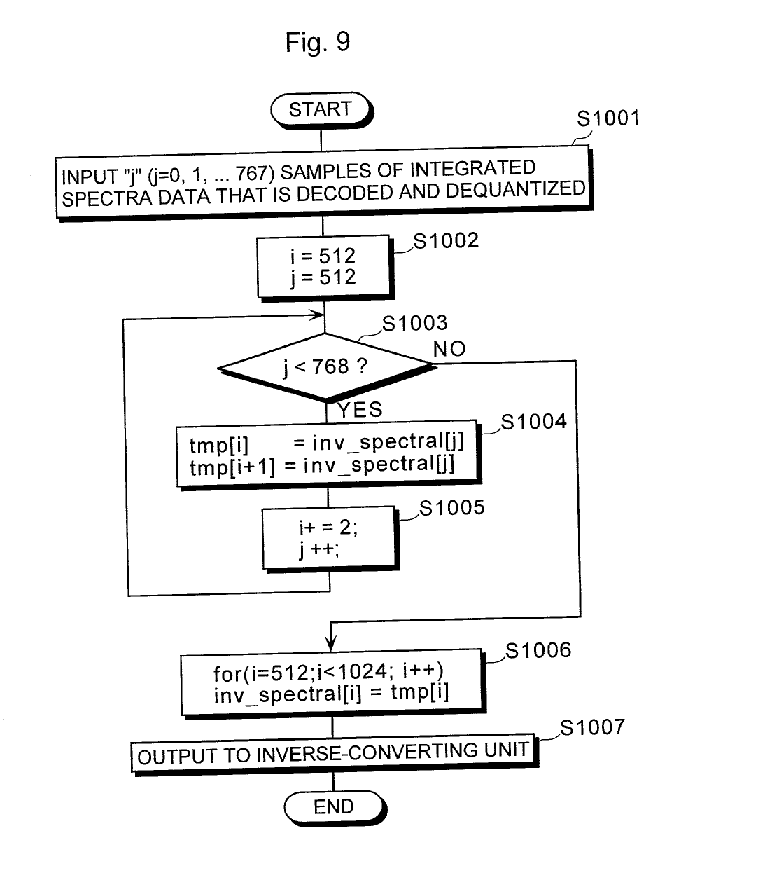

The spectral data expanding unit 126 performs the above expansion in accordance with the following procedure. FIG. 9 is a flowchart showing the processing of the spectral data expanding unit 126. In this figure, “I” and “j” represent ordinal numbers assigned to integration values of the integrated spectral data. The spectral data expanding unit 126 receives, from the dequantizing unit 125, integration values assigned ordinal numbers “j” (j=0, 1, . . . 767) of the integrated spectral data obtained after decoding and dequantizing (step S1001). Each of the received integration values of the spectral data is stored in a different storage region “inv_spectral [j]” (j=0,1, . . . 767) represented by one-dimensional array. The spectral data integrating unit 114 then places “512” into registers “i” and “j” to perform the following operation on the 512nd integration value (the first value in the higher band) and subsequent integration values (step S1002). The spectral data expanding unit 126 then judges whether “j” is lower than “768” (step S1003). If so, which means the expanding operation has not been completed, then an integration value in the storage region “inv_spectral [j]” is placed into temporary storage regions “temp [i]” and “temp [i+1]”, which are represented by one-dimensional array corresponding to i=512, 513, . . . 1023 (step S1004). For the present example, an integration value in the storage region “inv_spectral [512]” is placed into temporary storage regions “tmp [512]” and “tmp [513].”

After this, the spectral data expanding unit 126 increments “I” and “j” by “2” and “1”, respectively (step S1005), and the control flow returns to step S1003. As a result, “i” and “j” change to “514” and “513”, respectively.

When the spectral data expanding unit 126 repeats the processing from steps S1003-S1005 in this way while incrementing “i” and “j” by “2” and “1”, an integration value in a storage region “inv_spectral [513]” is expanded into two values in storage regions “tmp [514]” and “tmp [515]”. Similarly, an integration value in a storage region “inv_spectral [514]” is expanded into two values in the storage regions “tmp [516]” and “tmp [517].” In this way, each integration value of the spectral data outputted from the dequantizing unit 125 is expanded into two values in two temporary storage regions. When it is judged in step S1003 that “j” is not lower than “768”, the temporary storage regions “tmp [i]” (i=512, 513, . . . 1023) store 512 values of expanded spectral data in the higher band in which every two consecutive values have the same value. The spectral data expanding unit 126 then overwrites the values stored in the temporary storage regions “tmp [i]” (i=512, 513, . . . 1023) and values in the storage regions “inv_spectral [j]” (i=0, 1, . . . 511) onto output storage regions “inv_spectral [i]” (i=0, 1, . . . 1023) (step S1006), and outputs the values in this output storage regions to the inverse-converting unit 127 (step S1007). This completes the expanding processing for a frame.

As has been described, the present encoding device 111 integrates spectral data for a frame composed of 1,024 samples into spectral data composed of 768 samples. This reduces not only the load of quantization and encoding by the encoding device 111 but also the load of a transmission channel for transmitting an encoded audio bit stream. The decoding device 122 can reproduce high-quality audio data by restoring spectral data composed of 1,024 samples in the whole band from the integrated spectral data composed of a frame of 768 samples. In addition, when an encoded bit stream of the same size is used, each sample is allowed to have larger information amount than a conventional sample because the broadcast system 100 of the present embodiment sends a frame containing less samples. Accordingly, each sample in the encoded audio bit stream of the present invention can be represented with increased precision, and is reproduced as sound closer to original sound.

The encoding device 111 and the decoding device 122 of the present embodiment differ from the conventional encoding device and the conventional decoding device only in that the present devices 111 and 122 include the spectral data integrating unit 114 and the spectral data expanding unit 126. Accordingly, the present encoding device 111 and decoding device 122 can be easily realized without drastically changing the construction of the conventional encoding device and decoding device.

The broadcast system 100 of the present embodiment has been describes as a digital satellite broadcast system using the broadcast satellite 130. However, the present broadcast system 100 may be of course a CS (communication satellite) digital broadcast system that uses a communication satellite, or a digital terrestrial broadcast system. The encoding device and decoding device of the present invention can be applied not only to a transmitting device and a receiving device of such broadcast system but also to a content distributing system that uses a bidirectional communication network such as the Internet, or to a transmitting device and a receiving device in a telephone system. Moreover, the encoding device of the present invention can be used in a recording device that records an audio signal onto a recording medium such as a compact disc (CD), and the decoding device can be used in a playback device that reproduces the audio signal on such recording medium. The processing of the encoding device 111 and the decoding device 122 may be achieved by not only hardware but also software, or partly by hardware with the remaining part achieved by software.

In the above embodiment, the present invention is described by using MPEG-2 AAC as an example of conventional technique. The present invention, however, can be also applied to other existing audio encoding method, or other new audio encoding method.

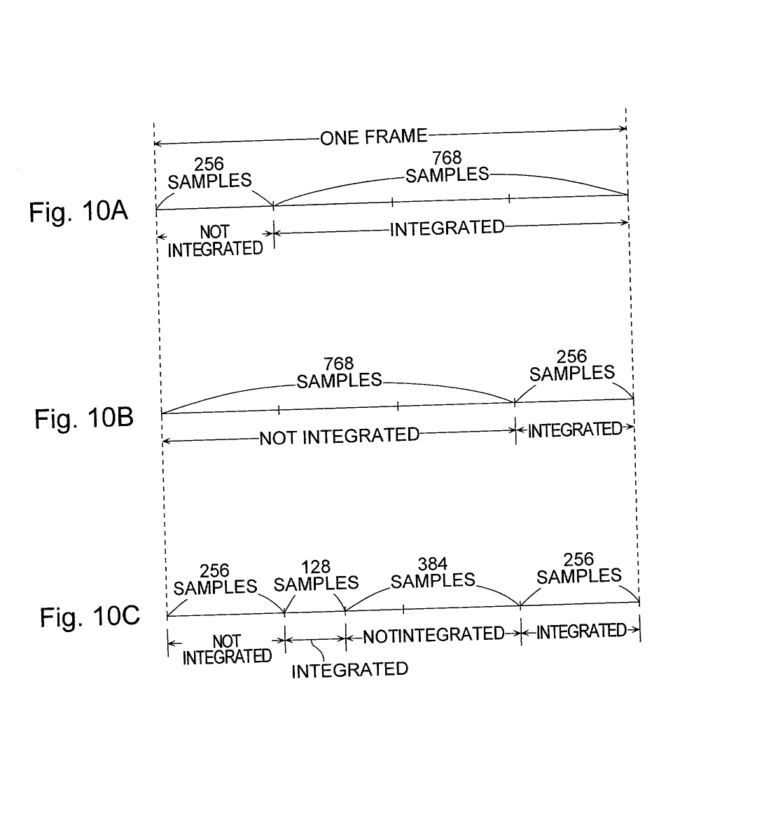

The spectral data integrating unit 114 of the above embodiment only integrates spectral data (512 samples) in the higher half of the whole band while leaving spectral data (512 samples) in the lower half of the band as it is. Such range of integration, however, is not limited to the above embodiment. For instance, it is possible to integrate more samples in the lower band of a frame as shown in FIG. 10A, where the first 256 samples in the lower band are outputted to the quantizing unit 115 without integration, and remaining 768 samples in a higher band are integrated. Alternatively, it is possible to integrate less samples in the higher half of the whole band as shown in FIG. 10A, where the first 768 samples in a lower band are outputted to the quantizing unit 115 without integration, and remaining 256 samples in a higher band are integrated. It is alternatively possible to integrate all the 1024 samples, or integrate, as shown in FIG. 10C, consecutive samples from the 256th sample to 319th, and consecutive samples from the 768th sample to the 1023rd within a frame. This is to say, integration may be performed on a plurality of discrete regions along the frequency axis.

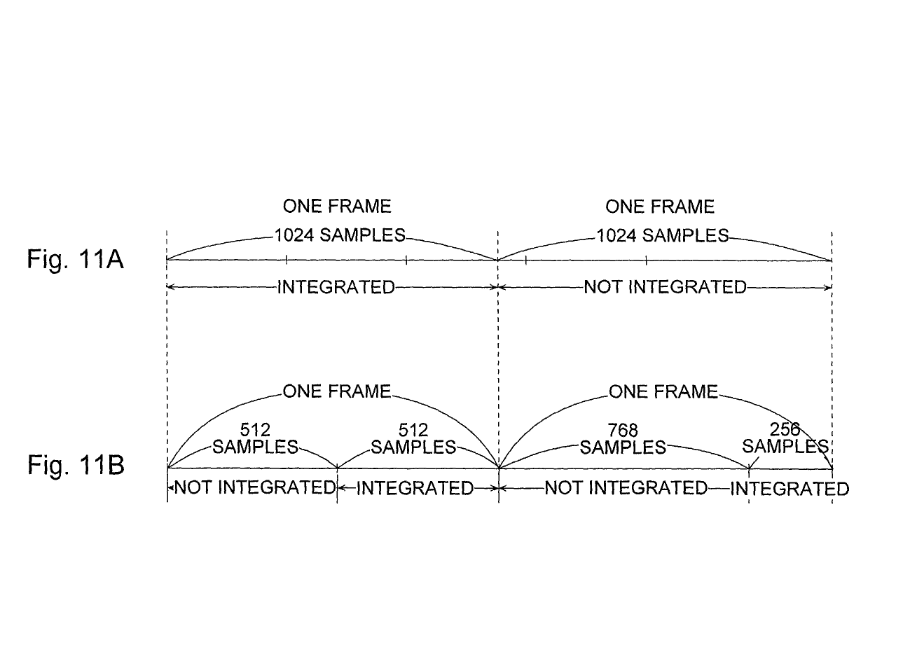

It is alternatively possible to designate different integration ranges for different frames, as shown in FIGS. 11A and 11B. In FIG. 11A, all the 1,024 samples are integrated in a frame, while in another frame none of the 1,024 samples are integrated. In FIG. 11B, 512 samples in a lower band are outputted to the quantizing unit 115 without integration, and the remaining 512 samples in a higher band are integrated for a frame. In the next frame, 768 samples in a lower band is outputted as they are, and 256 samples in a higher band are integrated.

In the above embodiment, the spectral data integrating unit 114 is described as generating the integration information 500 shown in FIG. 6 that designates an integration target range for each frame. However, the integration information 500 does not have to designate such integration target range. For instance, it can be decided beforehand for the encoding device 111 and the decoding device 122 that 512 samples in the higher band of every odd-numbered frame are integrated and that 256 samples that start with the 768th sample are integrated for every even-numbered frame. When an integration target range is predetermined in this way, the integration information 500 does not have to specify any integration target range.

In the above embodiment, the integration information 500 includes at least one block 520, which specifies contents of integrating operation. It is also described above that when different integration operations are performed within the same frame, methods for such different integration operations are recorded in the integration information 500. However, contents of the integration information 500 are not limited to this. For instance, when integration methods within each frame are decided beforehand, the integration information 500 may only contain one-bit flag indicating for each frame whether such integration is performed. When the same integration operation is performed on two consecutive frames, it is possible to omit generation of integration information for the latter frame.

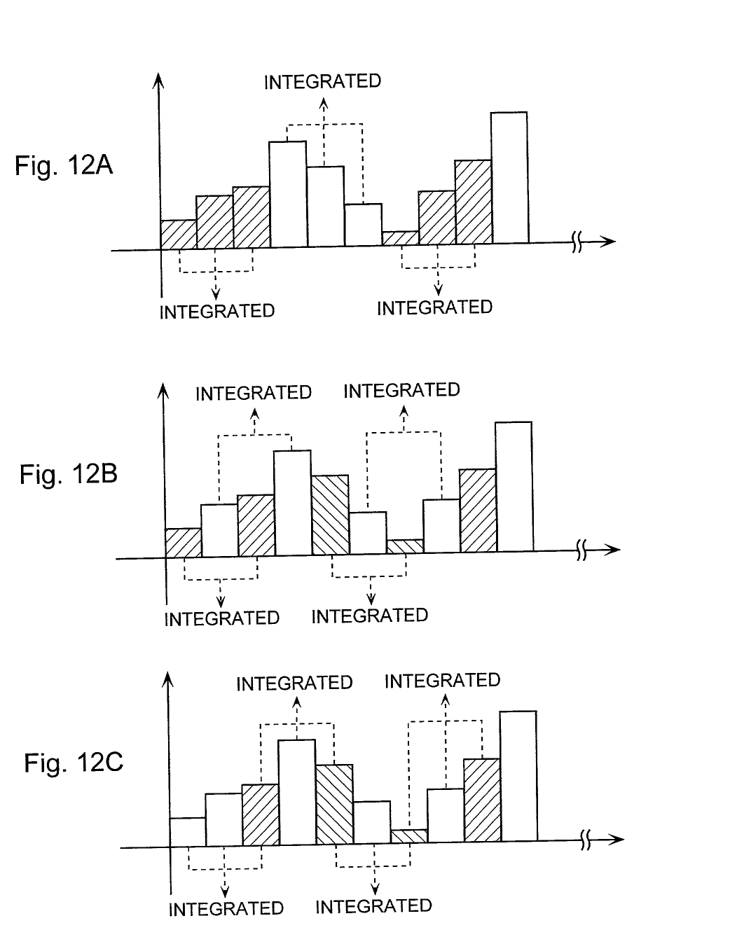

In the above embodiment, the spectral data integrating unit 114 integrates two consecutive samples of spectral data into one integration value. The integration manner of the present invention, however, is not limited to the above embodiment. FIG. 12A shows another example of combination of samples to be integrated together. As shown in the figure, three samples of the spectral data may be integrated together as one integration value, or more samples may be integrated together.

It is also possible to integrate non-consecutive samples as one integration value. FIG. 12B shows another example of combination of samples to be integrated together. As shown in the figure, every other sample may be selected to be integrated together. Similarly, it is possible to select every other sample and integrate, as one integration value, three successive samples that have been selected. Every two, three, or more samples, instead of every other value, may be selected to be integrated as one integration value. There may be overlaps in such selection of samples to be integrated. For instance, as shown in FIG. 12C, three consecutive samples may be selected to be integrated together as one integration value, and the first and last values, out of the selected three values, may overlap with the last and first values selected to constitute integration values adjacent to the integration value.

How samples are selected to be integrated together may differ according to a frame, or a band. For instance, it is possible to integrate two consecutive samples into one integration value in a frame and integrate three consecutive samples into one integration value in another frame. Alternatively, it is possible to integrate together every two consecutive samples for 512 samples in the lower band and integrate together every four consecutive samples for 512 samples in the higher band. It is alternatively possible to define how samples are combined as one integration value for each scale factor band. When this is performed, the number of samples to be integrated together may be determined in accordance with frequencies of the samples. For instance, more samples may be integrated together in a scale factor band at higher frequencies.

The number of samples to be integrated together may be determined in accordance with an actual value of each sample. For instance, when ten consecutive samples are zero in a high band, these ten values may be integrated as a single integration value of zero. Not only the number of samples to be integrated together, but also a calculation method of an integration value, an integration target range, combination of samples to be integrated, provision of weighing and its value, and the like may be determined in accordance with actual values of samples of spectral data. When such integration is performed, the spectral data integrating unit 114 stores, in advance, information that associates a different integrating method with each predicted pattern of spectral data within each frame. The spectral data integrating unit 114 specifies each pattern of spectral data within each frame by performing function conversion on the spectral data. If the specified pattern is included in the stored information, the spectral data integrating unit 114 uses an integration method associated with the specified pattern in the stored information. Some of the above items of an integration method may be decided beforehand for the encoding device and the decoding device and omitted from the integration information 500. The integration information 500 may therefore only include items that are generated based on actual spectral data.

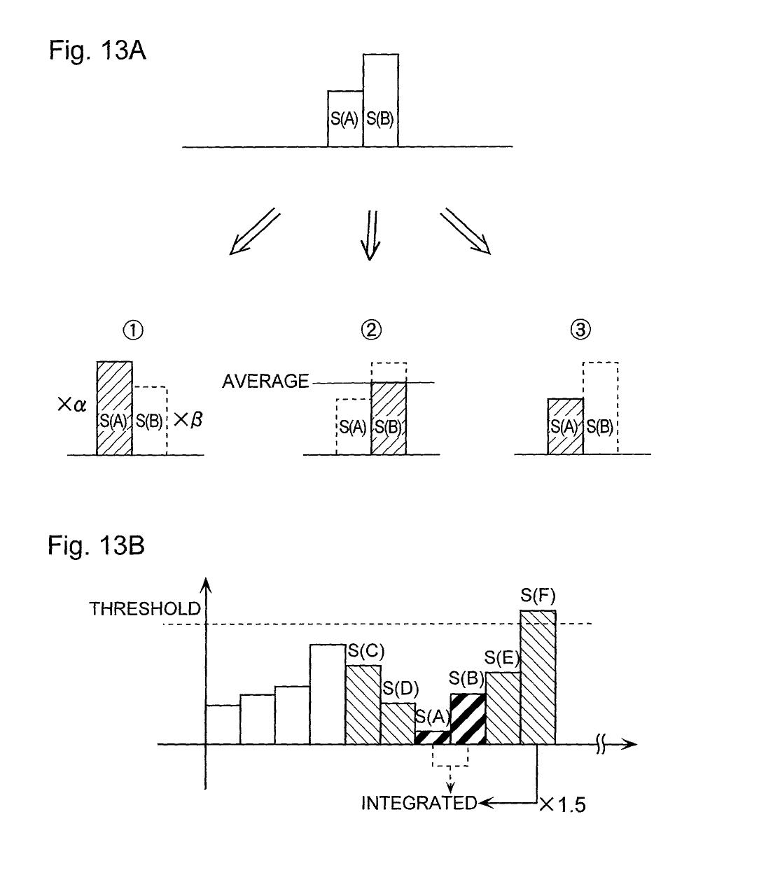

In the above embodiment, an integration value is a sample that has the largest absolute value among samples to be integrated together. The method for determining an integration value, however, is not limited to this embodiment. FIG. 13A shows an example calculation method for an integration value based on two consecutive samples. As shown in \mathring{1} in FIG. 13A, samples “S(A)” and “S(B)” of spectral data may be multiplied by factors “α” and “β”, respectively, to give them weights, and one of the weighted samples that has a larger absolute value than the other may be regarded as an integration value. As another example, as shown in FIG. 13B, an average of two samples “S(A)” and “S(B)” may be regarded as an integration value, and this average may be calculated from absolute values of the two samples “S(A)” and “S(B).” It is alternatively possible to give weights to two samples “S(A)” and “S(B)” and then regard an average of such weighted two samples as an integration value of the two. As in another example shown in \mathring{3} of FIG. 13A, it is alternatively possible to predetermine a position of a sample to be used as an integration value out of a plurality of samples to be integrated together. Alternatively, one sample in a lower frequency than the other sample may be always regarded as an integration value. It is of course possible to regard a sample at a higher frequency than the other as an integration value.

FIG. 13B shows another example method for calculating an integration value of two consecutive samples of the spectral data. As shown in the figure, after calculating an integration value in any of the stated manner, the spectral data integrating unit 114 may adjust the calculated integration value with reference to other samples adjacent to the samples integrated as the integration value. For instance, as shown in FIG. 13B, the spectral data integrating unit 114 refers to four samples “S(C)”, “S(D)”, “S(E)”, and “S(F)” that are arranged adjacent to two samples “S(A)” and “S(B)” on their both sides of higher and lower bands. If any of these samples “S(C)”, “S(D)”, “S(E)”, and “S(F)” exceeds a predetermined threshold value, the spectral data integrating unit 114 multiplies an integration value of the two values “S(A)” and “S(B)” by a weighting factor “1.5.” The number of samples that are referred to as described above is not limited to four, and may be two, six, or more. The spectral data integrating unit 114 may only refer to samples that are arranged on one of the higher- and lower-band sides of two samples to be integrated. The above weighing factor is not limited to “1.5”, and may be lower than “1.” For instance, when a sample adjacent to an integration value is extremely large, this integration value may be masked. In such a case, the weighing factor may be “0”, for instance.

Other methods for calculating an integration value may be also used. For instance, an integration value may be obtained by performing predetermined function conversion (not the one described above) on samples to be integrated together. The calculation method may differ between frames, bands, or scale factor bands.

Such calculation method for an integration value may be determined beforehand and shared by the encoding device and the decoding device, or written in the integration information 500. The integration information 500 may contain a method for expanding integrated spectral data by using integration values.

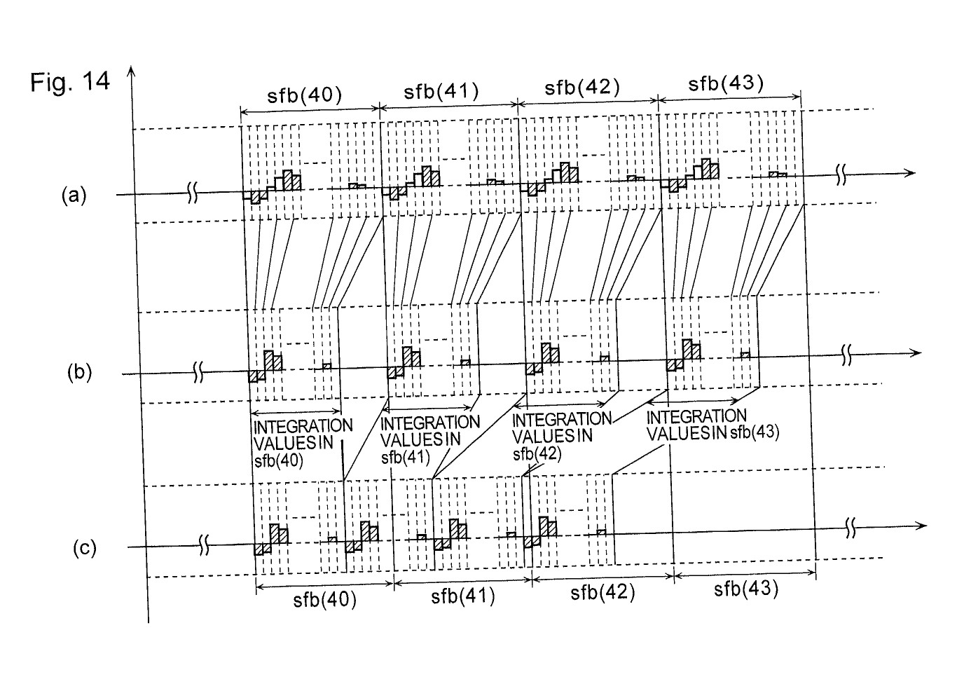

The number of samples included in a scale factor band may differ between before and after spectral data is integrated although such number of samples is the same before and after the integration in the above embodiment. FIG. 14A shows an example of spectral data and scale factor bands in a higher band before spectral data integration. FIG. 14B shows an example relationship between the spectral data in the higher band and scale factor bands after integration, and FIG. 14C shows the same relationship between the two for the above embodiment. In these figures, spectral data and scale factor bands in the lower band are not shown because such spectral data is not integrated and therefore neither the spectral data nor scale factor bands change before and after the integration. For ease of explanation, a scale factor band assigned number “40” is the first scale factor band in the higher band that includes 512 samples of spectral data. In the above embodiment, the spectral data integrating unit 114 integrates spectral data in accordance with the control flow shown in FIG. 5, and the integrated spectral data are placed in scale factor bands set by the converting unit 113. Accordingly, the integrated spectral data are placed, as shown in FIG. 14C, toward the left (i.e., lower-band side) in the figure in accordance with the number of samples that are not used as integration values, so that the number of scale factor bands in the higher band decreases after the integration. In this way, integration of spectral data of the above embodiment reduces not only the amount of quantized data to be sent as the encoded signal but also the number of scale factors that are also part of the encoded signal. This therefore drastically reduces the data amount of the encoded signal.

For the integration method of the present invention, however, the structure of the scale factor band is not limited to the above structure. Although the number of samples included in a scale factor band is defined in MPEG-2 AAC, this number may be changed for the present invention. For example, this number may be reduced to half after two samples are integrated as one integration value as shown in FIG. 14B. This enables highly precise quantization in each scale factor band within the integration target range although the number of scale factors is not reduced. Accordingly, the structure of scale factor bands shown in FIG. 15B is advantageous in that it can transfer more accurate audio data while reducing the data amount of the encoded signal by reducing the number of values making up the quantized data. Such change in the structure of a scale factor band before and after integration may be determined beforehand and notified to the encoding device and the decoding device, or may be encoded as integration information.

In the above embodiment, the spectral data expanding unit 126 expands one integration value into two samples. However, a single integration value may be duplicated to produce two samples. This is to say, the spectral data expanding unit 126 may duplicate each of 256 integration values in the higher band as one of two consecutive samples in the frequency domain to produce 512 samples. It is also possible to multiply each integration value by a weighing factor before duplicating the integration value. It is alternatively possible to multiply each of two expanded (or duplicated) samples by a weighing factor.

The spectral data expanding unit 126 of the present invention may expand integrated spectral data in accordance with integration information if such information is available. Alternatively, the spectral data expanding unit 126 may expand integrated spectral data in accordance with its own expanding method regardless of provision of integration information, or any other method.

### INDUSTRIAL APPLICABILITY

The encoding device of the present invention is useful as an audio encoding device used in a broadcast station for a satellite broadcast, including BS (broadcast satellite) and CS (communication satellite) broadcasts, or as an audio encoding device used for a content distributing server that distributes contents via a communication network such as the Internet. The present encoding device is also useful as a program executed by a general-purpose computer to perform audio signal encoding.

The decoding device of the present invention is useful not only as an audio decoding device provided in an STB for home use but also as a program executed by a general-purpose computer to perform audio signal decoding, a circuit board and an LSI provided in an STB or a general-purpose computer, and an IC card inserted into an STB or a general-purpose computer.

What is claimed is:

1. An encoding device that receives and encodes an audio signal, comprising:
a converting unit operable to extract a part of the received audio signal, the extracted part forming a frame corresponding to a predetermined period, and to convert the extracted part into a spectrum in a frequency domain, the spectrum including a plurality of sets of spectral data;
an integrating unit operable to integrate at least two sets of spectral data in a part of the spectrum into fewer sets of spectral data, hereafter called integration data, and to output the fewer sets of integration data, wherein the part of the spectrum corresponds to a predetermined frequency band; and
an encoding unit operable to quantize and encode the sets of integration data to produce and output the encoded data.

2. The encoding device of claim 1,
wherein the integrating unit executes a function that assesses the at least two sets of spectral data and that integrates the assessed sets of spectral data into at least one set of integration data.

3. The encoding device of claim 2,
wherein the at least two sets of spectral data assessed by the function are consecutively arranged in the frequency domain.

4. The encoding device of claim 2,
wherein the at least two sets of spectral data assessed by the function are discontiguously arranged in the frequency domain.

5. The encoding device of claim 2,
wherein out of the at least two assessed sets of spectral data, the function specifies a set of spectral data having a largest absolute value, regards the specified set of spectral data as a set of integration data, and integrates the at least two assessed sets of spectral data into the set of integration data.

6. The encoding device of claim 2,
wherein the function specifies an average of the at least two assessed sets of spectral data, regards the specified average as a set of integration data, and integrates the at least two assessed sets of spectral data into the set of integration data.

7. The encoding device of claim 2,
wherein out of the at least two assessed sets of spectral data, the function specifies a set of spectral data, regards the specified set of spectral data as a set of integration data, and integrates the at least two assessed sets of spectral data into the set of integration data, wherein the specified set of spectral data is present in a predetermined position with respect to other assessed sets of spectral data in the frequency domain.

8. The encoding device of claim 2,
wherein the function assigns weights to the at least two assessed sets of spectral data before integrating the assessed sets of spectral data.

9. The encoding device of claim 2,
wherein the integrating unit selects a function for each frame, and integrates at least two sets of spectral data by executing the selected function.

10. The encoding device of claim 2,
wherein the function executed by the integrating unit is determined in accordance with at least one of the plurality of sets of spectral data that constitute the spectrum.

11. The encoding device of claim 2,
wherein the function specifies a value based on the at least two assessed sets of spectral data and other sets of spectral data adjacent to the assessed sets of spectral data, regards the specified value as a set of integration data, and integrates the at least two assessed sets of spectral data into the set of integration data.

12. The encoding device of claim 1,
wherein the converting unit divides the plurality of sets of spectral data constituting the spectrum into a plurality of groups in the frequency domain, each of the plurality of groups including a predetermined number of sets of spectral data,
the integrating unit arranges each set of integration data and unintegrated sets of spectral data that constitute the spectrum in the frequency domain, and divides the arranged sets of data into a plurality of groups that each include a predetermined number of arranged sets of data, wherein each predetermined number is same as a number used by the converting unit when dividing the plurality of sets of spectral data, and
the encoding unit quantizes each set of data included in each group, which is divided by the integrating unit, by using a parameter assigned to the group.

13. The encoding device of claim 1,
wherein the integrating unit includes an information generating unit that generates integration information showing an integration method for integrating the at least two sets of spectral data, and
the encoding unit also encodes the integration information, inserts the encoded integration information into the produced encoded data, and outputs the encoded data containing the encoded integration information.

14. The encoding device of claim 13,
wherein when same integration method is used for sets of spectral data of two consecutive frames, the information generating unit does not generate integration information for sets of spectral data of the latter frame.

15. A decoding device that receives and decodes encoded data generated from a frame of an audio signal and restores the audio signal, wherein the frame is extracted by an encoding device from the audio signal at predetermined time intervals, the decoding device comprising:
a dequantizing unit operable to decode and dequantize the received encoded data to produce dequantized data, and convert the dequantized data into a spectrum in a frequency domain, wherein the spectrum includes a plurality of sets of spectral data;
an expanding unit operable to expand each of certain sets of spectral data, out of the plurality of sets of spectral data, into at least two sets of spectral data by using a predetermine function, the certain sets of spectral data corresponding to a predetermined frequency band; and
an inverse-converting unit operable to convert each expanded set of spectral data into an audio signal in a time domain and to output the audio signal.

16. The decoding device of claim 15,
wherein the predetermined function expands each of the certain sets of spectral data into at least two sets of spectral data by duplicating each of the certain sets of spectral data.

17. The decoding device of claim 15,
wherein the predetermined function assigns weights to the certain sets of spectral data before expanding the certain sets of spectral data.

18. The decoding device of claim 15,
wherein when the encoded data contains integration information showing an integration method for integrating at least two sets of spectral data into the certain sets of spectral data, the dequantizing unit extracts the integration information from the encoded data, and
the expanding unit expands the certain sets of spectral data in accordance with the extracted integration information.

19. The decoding device of claim 18,
wherein when the dequantizing unit does not extract integration information, the expanding unit expands the certain sets of spectral data in accordance with integration information that was extracted by the dequantizing unit most recently.

20. A broadcast system comprising an encoding device and a decoding device, wherein the encoding device receives and decodes an audio signal to produce encoded data, and the decoding device receives the encoded data from the encoding device and decodes the received encoded data to restore the audio signal,
the encoding device includes:
a converting unit operable to extract a part of the received audio signal, the extracted part forming a frame corresponding to a predetermined period, and to convert the extracted part into a spectrum in a frequency domain, the spectrum including a plurality of sets of spectral data;
an integrating unit operable to integrate, by using a first predetermined function, at least two sets of spectral data in a part of the spectrum into fewer sets of spectral data, hereafter called integration data, and to output the fewer sets of integration data, wherein the part of the spectrum corresponds to a predetermined frequency band; and
an encoding unit operable to quantize and encode the sets of integration data to produce and output the encoded data,
the decoding device includes:
a dequantizing unit operable to decode and dequantize the encoded data to produce dequantized data, and convert the dequantized data into a spectrum in the frequency domain, wherein the spectrum includes the sets of integration data;
an expanding unit operable to expand each of the sets of integration data into at least two sets of spectral data by using a second predetermine function; and
an inverse-converting unit operable to convert each expanded set of spectral data to produce and output the audio signal in a time domain.

21. A program to have a computer function as an encoding device that receives and decodes an audio signal, including:
a converting step for extracting a part of the received audio signal, the extracted part forming a frame corresponding to a predetermined period, and converting the extracted part into a spectrum in a frequency domain, the spectrum including a plurality of sets of spectral data;
an integrating step for integrating, in accordance with a predetermined function, at least two sets of spectral data in a part of the spectrum into fewer sets of spectral data, hereafter called integration data, and outputting the fewer sets of integration data, wherein the part of the spectrum corresponds to a predetermined frequency band; and
an encoding step for quantizing and encoding the sets of integration data to produce and output the encoded data.

22. A program to have a computer function as a decoding device that receives and decodes encoded data to restore an audio signal, the program including:
a dequantizing step for decoding and dequantizing the received encoded data to produce dequantized data, and converting the dequantized data into a spectrum in a frequency domain, wherein the spectrum includes a plurality of sets of spectral data;
an expanding step for expanding each of certain sets of spectral data, out of the plurality of sets of spectral data, into at least two sets of spectral data by using a predetermine function, the certain sets of spectral data corresponding to a predetermined frequency band; and
an inverse-converting step for converting each expanded set of spectral data into an audio signal in a time domain and outputting the audio signal.
